(19) United States
(12) Patent Application Publication
(10) Pub. No.: US 2005/0017612 A1
(43) Pub. Date: Jan. 27, 2005

(54) Door assembly

(76) Inventor: Myung Sik Park, Changwon-si (KR)

Correspondence Address: MCKENNA LONG & ALDRIDGE LLP;Song K. Jung, 1900 K Street, N.W., Washington, DC, 20006, US

(21) Appl. No.: 10/867,825

(22) Filed: Jun. 16, 2004

(30) Foreign Application Priority Data
Jul. 25, 2003 (KR) P2003-0051345

(51) Int. Cl. B08B 3/12; D06F 37/00; A47B 49/00; A47B 88/00

(52) U.S. Cl. 312/326

(57) ABSTRACT

Door assembly including a cabinet with an opening at a front, a door for opening/closing the opening, and a hinge assembly having rotating shafts slanted with respect to an axis vertical to the ground, for rotatably mounting the door at one side of the cabinet, thereby opening/closing the door, more conveniently.

This application claims the benefit of the Korean Application No. P2003-0051345 filed on Jul. 25, 2003, which is hereby incorporated by reference.

### BACKGROUND OF THE INVENTION

1. Field of the Invention

The present invention relates to door assemblies, and more particularly, to a door assembly with a slanted rotating shaft.

2. Background of the Related Art

In general, the washing machines wash laundry by using chemical dissolution, and mechanical impact. Of the washing machines, a drum type washing machine has a washing capacity larger than a pulsator type washing machine owing to a drum lying in a horizontal position in the drum type washing machine. Moreover, the drum type washing machine causes almost no problem of laundry entangling.

A related art drum type washing machine will be described with reference to the attached drawings. FIG. 1 illustrates a section of a related art drum type washing machine.

Referring to FIG. 1, the related art drum type washing machine is provided with a cabinet 1, a tub 2, a drum 3, and a motor S. The cabinet 1 has the tub 2 provided therein, and the tub 2 is held in position with dampers 7 and springs 6. The tub 2 has a cylindrical drum 3 provided therein, and the drum 3 is connected to the motor 5 with a drum shaft.

The motor 5 is on a rear surface of the tub 2, and has a rotor 5b and a stator 5a. Rotation power is transmitted from the rotor 5b to the drum 3 via the drum shaft.

In the meantime, there is a door 8 rotatably mounted on a front surface of the cabinet 1 for opening/closing an opening of the drum 3. There is gasket 9 provided between the door 8 and the drum 3 for sealing the drum 3. There is a controller 10 for controlling entire operation of the washing machine under the manipulation of the user.

The rotation power is transmitted from the rotor 5b to the drum 3 through the drum shaft 4, and the laundry is washed as the laundry is lifted by baffles 3a and dropped by gravity.

The related art washing machine has the following problems.

In the drum type washing machine, the door swings horizontally with respect to ground around a vertical axis. Opposite to this, the user opens the door by pulling his arm from a lower side to an upper side. Consequently, because a direction of application of force of the user and a swing direction of the door differ, much force is required for the arm and the user is not convenient.

### SUMMARY OF THE INVENTION

Accordingly, the present invention is directed to a door assembly that substantially obviates one or more of the problems due to limitations and disadvantages of the related art.

An object of the present invention is to provide a door assembly which enables to swing the door around a slanted rotation shaft while structural change of the drum type washing machine is minimized.

Additional features and advantages of the invention will be set forth in the description which follows, and in part will be apparent to those having ordinary skill in the art upon examination of the following or may be learned from practice of the invention. The objectives and other advantages of the invention will be realized and attained by the structure particularly pointed out in the written description and claims hereof as well as the appended drawings.

To achieve these objects and other advantages and in accordance with the purpose of the present invention, as embodied and broadly described herein, the door assembly includes a cabinet with an opening at a front, a door for opening/closing the opening, and a hinge assembly having rotating shafts slanted with respect to an axis vertical to the ground, for rotatably mounting the door at one side of the cabinet.

The hinge assembly includes a fixing part at one side of the cabinet having slanted rotating shafts projected therefrom, and grooves at one side of the door for receiving the fixing part and the rotating shafts. The fixing part includes a base part fixed to the front of the cabinet, an upper horizontal part projected forward from an upper part of the base part, and a lower horizontal part projected forward from a lower part of the base part at a length longer than the upper horizontal part by a predetermined amount.

The horizontal parts include ‘L’ formed ends bent toward the opening, respectively. The groove includes a horizontal groove for inserting the horizontal member, and a fastening groove for rotatably fastening the slated rotating shaft. The rotating shaft is provided both to an upper surface and a lower surface of each of the horizontal parts.

The base part is preferably formed as one unit with the front of the cabinet. The door includes a door frame formed along a circumference of the opening, a door glass mounted on a central part of the door frame.

The door frame includes a front slanted backward at a predetermined angle from an axis vertical to the ground. The door frame has a thickness becoming the thicker as it goes from an upper part to a lower part.

In other aspect of the present invention, there is provided a door assembly including a cabinet with an opening at a front, a door for opening/closing the opening, and a hinge assembly for rotatably mounting the door at one side of the cabinet, wherein the hinge assembly includes a fixing part having a plurality of horizontal parts projected forward from one side of the cabinet, rotating shafts projected from ends of the horizontal parts along the same axis direction slanted backward with respect to an axis vertical to the ground, and grooves at one side of the door for receiving the horizontal parts and the rotating shafts.

The horizontal parts have projected lengths which become the longer as it goes from upper side one to a lower side one. The horizontal parts include ‘L’ formed ends bent toward the opening, respectively. The fixing part is formed as one unit with the front of the cabinet. The rotating shaft is provided both to an upper surface and a lower surface of each of the horizontal parts.

The door includes a door frame formed along a circumference of the opening, and a door glass mounted on a central part of the door frame.

The door frame includes a front slanted at a predetermined angle from an axis vertical to the ground. The door frame has a thickness becoming the thicker as it goes from an upper part to a lower part.

The door frame includes a handle at one side slanted in correspondence to the slanted rotating shaft. The groove includes a horizontal groove for inserting the horizontal part, and a fastening groove for fastening the slanted rotating shaft rotatably.

It is to be understood that both the foregoing description and the following detailed description of the present invention are exemplary and explanatory and are intended to provide further explanation of the invention claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention.

In the drawings;

FIG. 1 illustrates a section of a related art drum type washing machine;

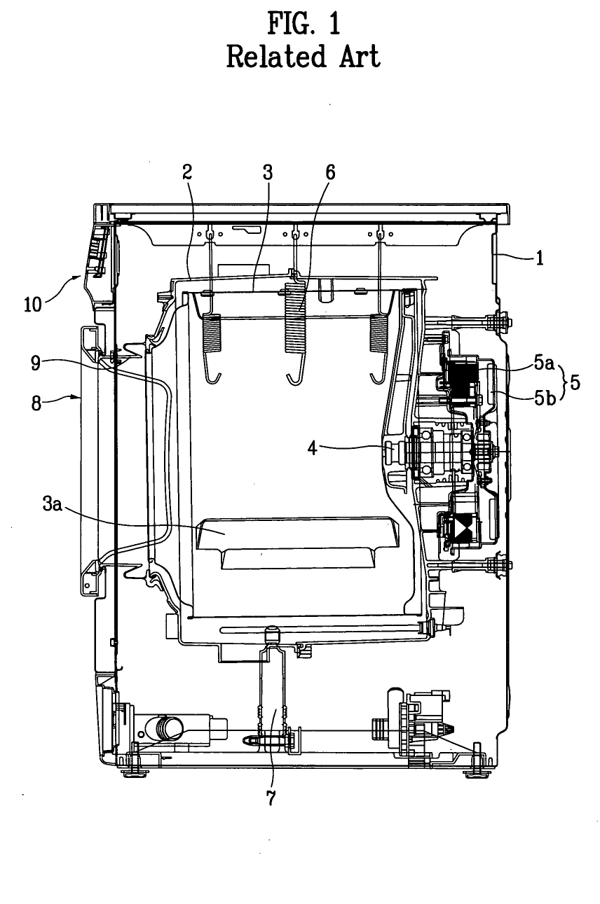

FIG. 2 illustrates a perspective view of a drum type washing machine in accordance with a preferred embodiment of the present invention;

FIG. 3 illustrates a section of a drum type washing machine in accordance with a preferred embodiment of the present invention;

FIG. 4 illustrates a side view of a door assembly of a drum type washing machine in accordance with a preferred embodiment of the present invention;

FIG. 5 illustrates a side section of a hinge assembly in accordance with a preferred embodiment of the present invention;

FIG. 6 illustrates a plan view of a hinge assembly in accordance with a preferred embodiment of the present invention; and

FIG. 7 illustrates a diagram showing a door in accordance with a preferred embodiment of the present invention.

### DETAILED DESCRIPTION OF THE PREFERRED EMBODIMENT

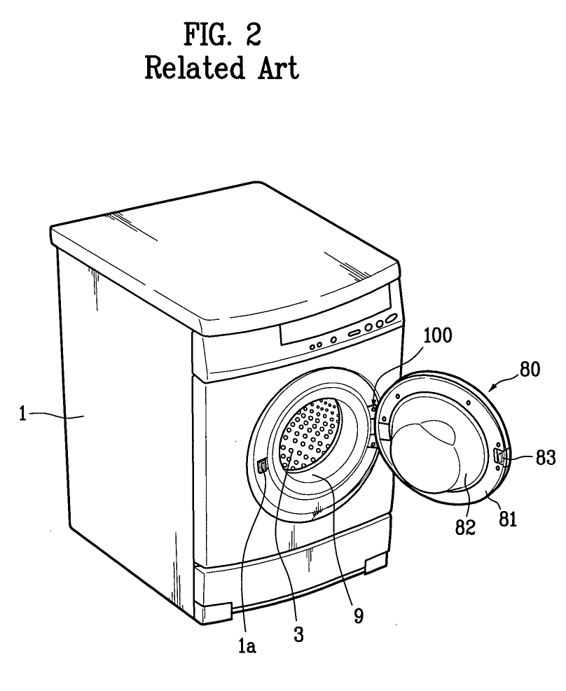

Reference will now be made in detail to the preferred embodiments of the present invention, examples of which are illustrated in the accompanying drawings FIG. 2˜7. In describing the embodiments of the present invention, same parts will be given the same names and reference symbols, and repetitive description of which will be omitted.

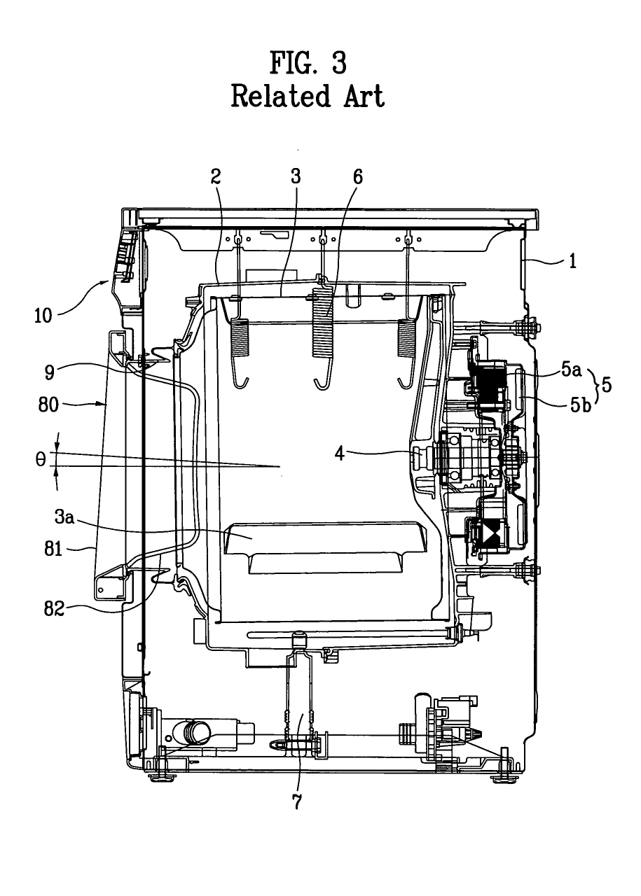

FIG. 2 illustrates a perspective view of a drum type washing machine in accordance with a preferred embodiment of the present invention, and FIG. 3 illustrates a section of a drum type washing machine in accordance with a preferred embodiment of the present invention.

Referring to FIGS. 2 and 3, the drum type washing machine includes a cabinet 1, a tub 2, a drum 3, a motor 5, and a hinge assembly with a rotating shaft.

The cabinet 1 has a tub 2 therein for holding washing water, and the tub 2 is held in position by dampers 7 and springs 6. The tub 2 has a drum 3 rotatably mounted therein. For this, a rear end of the drum 3 is connected to the motor 5 with a drum shaft 4.

The motor 5 has a stator 5a and a rotor 5b. Rotating power is transmitted from the rotor 5b to the drum 3 through the drum shaft 4. There is a door 80 at a front of cabinet 1 for closing/opening the opening through which laundry is introduced. The door 80 has a door frame 81 and a door glass 82. There is a hook 83 at one side of the door frame 81 for joining with a locking part 1 a at the cabinet.

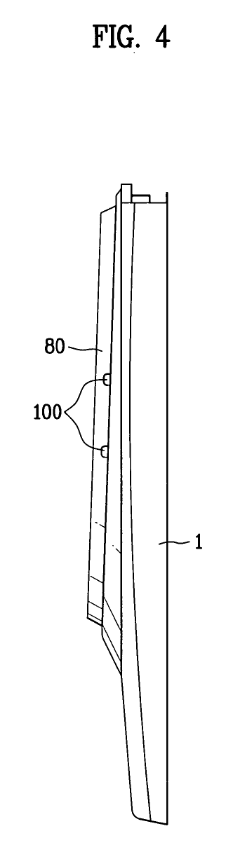

In the meantime, the door 80 is rotatably mounted on the cabinet 1 with a hinge assembly 100 at one side of the cabinet 1. FIG. 4 illustrates a side view of a door assembly of a drum type washing machine in accordance with a preferred embodiment of the present invention.

Referring to FIG. 4, the hinge assembly 100 is at one side of the opening for coupling the door 80 to the front of the cabinet 1. The assembly 100 has a rotating shaft slanted backward with respect to an axis vertical to ground, for rotatably fastening the door 80 to one side of the cabinet 1.

A front of the door 80 is slanted backward with respect to an axis vertical to the ground. As described later, a thickness of the door 80 becomes the thicker as it goes the farther from an upper part to a lower part of the slanted shaft of the hinge assembly 100.

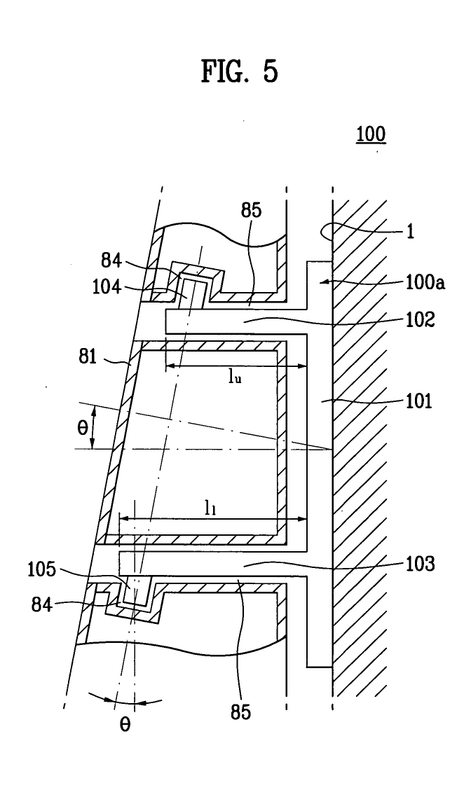

FIG. 5 illustrates a side section of a hinge assembly in accordance with a preferred embodiment of the present invention.

Referring to FIG. 5, the hinge assembly 100 includes a fixing part 100a, and grooves 84, and 85. The fixing part 100a is at one side of the opening in the front of the cabinet 1. The fixing part 100a includes a base part 101, an upper horizontal part 102, and a lower horizontal part 103. The base part 101 is provided to a front surface of the cabinet 1. The horizontal part 102, or 103 extends forward from the washing machine, and has a slanted rotating shaft 104 at an end.

It is preferable that the fixing part 100a is formed as a unit with the cabinet 1 at the front thereof. That is, by forming as one unit with the cabinet, rather than assembling as an independent component, a more convenient assembly structure of the door assembly can be provided.

In the meantime, the greater a number of the horizontal parts becomes, the more the load on the horizontal parts becomes distributed. Therefore, for more stable swing of the door, it is preferable that there are two or more than two of the horizontal parts and the slanted rotating shafts.

Referring to FIG. 5, the upper horizontal part 102 is projected forward from the upper part of the base part 101, and the lower horizontal part 103 is projected forward from the lower part of the base part 101. In this instance, a projection length “lᵤ” of the upper horizontal part 102 is longer than a projection length 1 of the lower horizontal part 103.

In the meantime, the rotating shafts 104 are projected along the same slanted axis direction. That is, the rotating shafts 104 are on the same line. In this instance, it is preferable that the rotating shafts 104 are projected along the same slanted axis direction with respect to an axis vertical to the ground.

As shown, the rotating shafts 104 are projected from an upper surface of the upper horizontal part 102 and a lower surface of the lower horizontal part 103. On the other hand, the rotating shafts 104 may be projected from the upper surface and the lower surface of each of the upper, and lower horizontal parts 102, and 103 along the same axis direction. In this instance, the door 80 can swing around the rotating shafts 104 provided both the upper and lower surfaces of the horizontal parts 102, and 103.

While a front of the door frame 81 is slanted in correspondence to the slanted rotating shafts 104, a rear of the door frame 81 is vertical to the ground so that the rear of the door frame 81 comes into close contact with the front of the cabinet 1. According to this, the thickness of the door frame 81 becomes the thicker as it goes from an upper side to a lower side of the door frame 81.

It is preferable that the front of the cabinet 1 is also slanted in correspondence to the slanted front of the door frame 81. By this, an outer appearance of the washing machine can be improved as a front surface of the washing machine is continuous. It is also preferable that a door 80 handle is slanted with respect to a vertical axis in correspondence to slant of the front of the door 80.

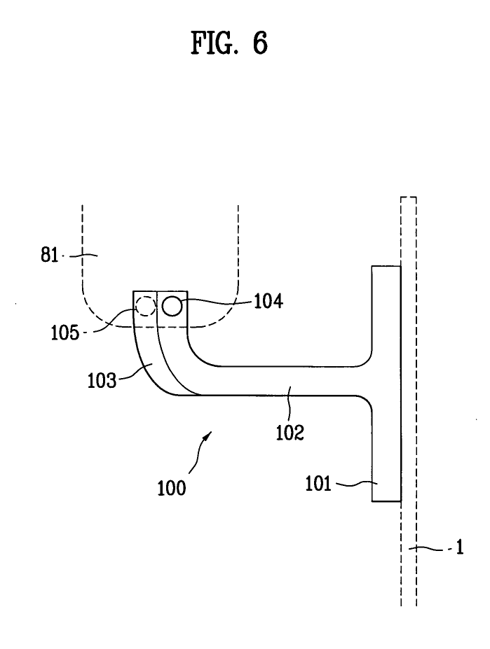

FIG. 6 illustrates a plan view of a hinge assembly in accordance with a preferred embodiment of the present invention.

Referring to FIG. 6, it is preferable that ends of respective horizontal parts 102, and 103 are bent in ‘L’ forms toward the opening in the cabinet, so that the ends of the horizontal parts 102, and 103 are closer to the opening in the front of the cabinet.

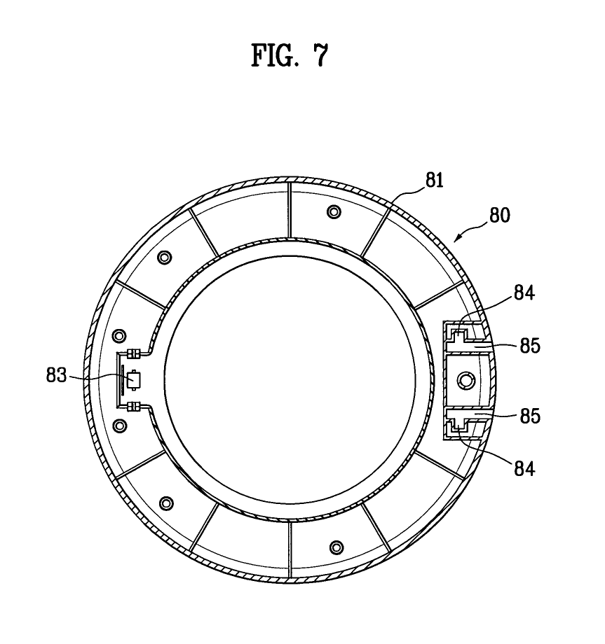

FIG. 7 illustrates a diagram showing a door in accordance with a preferred embodiment of the present invention.

Referring to FIG. 7, the door 80 includes the door glass 82, and the door frame 81. The door frame 81 is formed along a circumference of the opening in the front of the cabinet, and the door glass 82 is mounted at a central part of the door frame 81. The door glass 82 is recessed to an inside of the washing machine.

The door 80 has grooves at one side for inserting the horizontal parts 102, and 103 and the rotating shafts 104. The groove includes a horizontal groove 85 and a fastening groove 84. The horizontal parts 102, and 103 are inserted in the horizontal grooves 85 respectively, and the slanted rotating shafts 104 are rotatably fastened in the fastening grooves 84. Therefore, the grooves 84, and 85 may be formed in a variety of forms according to numbers and forms of the horizontal parts 102, and 103, and the rotating shafts 104.

The operation of the door assembly of the present invention will be described.

Referring to FIGS. 3˜5, the rotating shaft 104 of the door 80 is slanted backward at an angle from an axis vertical to the ground, so that the door 80 swings around the rotating shafts 104 in a state slanted with respect to a horizontal plane at a predetermined angle. Accordingly, when the user pulls, and opens the door 80, the user's arm is required to exert little force and convenient to handle because a user's force direction and a swing direction of the door 80 is the same.

As has been described, the door assembly of the present invention has the following advantages.

The swing of the door assembly in a slanted position around the slanted rotating shaft permits to improve user's convenience because a swing direction of the door and the direction of the force of the user's arm are almost same.

Moreover, a slanted type door can be embodied while minimizing design change of the cabinet.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A door assembly comprising:
a cabinet with an opening at a front;
a door for opening/closing the opening; and
a hinge assembly having rotating shafts slanted with respect to an axis vertical to the ground, for rotatably mounting the door at one side of the cabinet.

2. The door assembly as claimed in claim 1, wherein the hinge assembly includes;
a fixing part at one side of the cabinet having slanted rotating shafts projected therefrom, and
grooves at one side of the door for receiving the fixing part and the rotating shafts.

3. The door assembly as claimed in claim 2, wherein the fixing part includes;
a base part fixed to the front of the cabinet,
an upper horizontal part projected forward from an upper part of the base part, and
a lower horizontal part projected forward from a lower part of the base part at a length longer than the upper horizontal part by a predetermined amount.

4. The door assembly as claimed in claim 3, wherein the horizontal parts include ‘L’ formed ends bent toward the opening, respectively.

5. The door assembly as claimed in claim 3, wherein the groove includes;
a horizontal groove for inserting the horizontal member, and
a fastening groove for rotatably fastening the slated rotating shaft.

6. The door assembly as claimed in claim 3, wherein the rotating shaft is provided both to an upper surface and a lower surface of each of the horizontal parts.

7. The door assembly as claimed in claim 2, wherein the base part is formed as one unit with the front of the cabinet.

8. The door assembly as claimed in claim 1, wherein the door includes;
a door frame formed along a circumference of the opening, a door glass mounted on a central part of the door frame.

9. The door assembly as claimed in claim 8, wherein the door frame includes a front slanted backward at a predetermined angle from an axis vertical to the ground.

10. The door assembly as claimed in claim 3, wherein the door frame has a thickness becoming the thicker as it goes from an upper part to a lower part.

11. A door assembly comprising:
a cabinet with an opening at a front;
a door for opening/closing the opening; and
a hinge assembly for rotatably mounting the door at one side of the cabinet, wherein the hinge assembly includes;
a fixing part having a plurality of horizontal parts projected forward from one side of the cabinet,
rotating shafts projected from ends of the horizontal parts along the same axis direction slanted backward with respect to an axis vertical to the ground, and
grooves at one side of the door for receiving the horizontal parts and the rotating shafts.

12. The door assembly as claimed in claim 11, wherein the horizontal parts have projected lengths which become the longer as it goes from upper side one to a lower side one.

13. The door assembly as claimed in claim 11, wherein the horizontal parts include ‘L’ formed ends bent toward the opening, respectively.

14. The door assembly as claimed in claim 11, wherein the fixing part is formed as one unit with the front of the cabinet.

15. The door assembly as claimed in claim 11, wherein the rotating shaft is provided both to an upper surface and a lower surface of each of the horizontal parts.

16. The door assembly as claimed in claim 11, wherein the door includes;
a door frame formed along a circumference of the opening, and
a door glass mounted on a central part of the door frame.

17. The door assembly as claimed in claim 16, wherein the door frame includes a front slanted at a predetermined angle from an axis vertical to the ground.

18. The door assembly as claimed in claim 16, wherein the door frame has a thickness becoming the thicker as it goes from an upper part to a lower part.

19. The door assembly as claimed in claim 16, wherein the door frame includes a handle at one side slanted in correspondence to the slanted rotating shaft.

20. The door assembly as claimed in claim 11, wherein the groove includes;
a horizontal groove for inserting the horizontal part, and
a fastening groove for fastening the slanted rotating shaft rotatably.
